(19) United States
(12) Patent Application Publication
(10) Pub. No.: US 2010/0314520 A1
(43) Pub. Date: Dec. 16, 2010

(54) SLOPE ADAPTING MOUNTING ARRANGEMENTS

(75) Inventor: Ted Collmar, Strongsville, OH (US)

Correspondence Address: CALFEE HALTER & GRISWOLD, LLP, 800 SUPERIOR AVENUE, SUITE 1400, CLEVELAND, OH, 44114, US

(73) Assignee: THE L.D. KICHLER CO., Cleveland, OH (US)

(21) Appl. No.: 12/816,604

(22) Filed: Jun. 16, 2010

Related U.S. Application Data
(60) Provisional application No. 61/187,478, filed on Jun. 16, 2009.

(51) Int. Cl. F16M 13/00; B23P 11/00

(52) U.S. Cl. 248/291.1; 29/525.02

(57) ABSTRACT

A slope adapting mounting arrangement includes a mounting coupler and a mounting bracket. The mounting coupler is configured to attach to a fixture and includes opposed first and second projections. The mounting bracket includes a mounting base defining a mounting plane, and first and second side walls extending from the mounting base and laterally spaced to receive the mounting coupler therebetween. The first and second side walls include first and second recesses for pivotable bearing engagement with the corresponding first and second projections of the mounting coupler. The pivotable bearing engagement between the first and second protrusions and the first and second recesses permits positioning the mounting coupler at any angle within a pivot range of the mounting coupler with respect to a mount axis substantially perpendicular to the mounting plane. The pivotable bearing engagement also prevents the mounting coupler from axially rotating with respect to the mounting bracket.

### CROSS-REFERENCE TO RELATED APPLICATION

This application claims priority to, and any other benefit of, U.S. Provisional Patent Application Ser. No. 61/187,478, entitled SLOPE ADAPTING MOUNTING ARRANGEMENTS and filed Jun. 16, 2009, the entire disclosure of which is fully incorporated herein by reference.

### BACKGROUND

Mountable fixtures, such as, for example, ceiling fans and lighting fixtures, are often mounted to sloped or angled ceilings. To allow for mounting to ceilings of varying slopes, a slope adapting mounting arrangement may be provided, which allows for adjustment of an angle of a fixture coupling (e.g., a downrod mounting coupler for mounting to the downrod of a ceiling fan) with respect to a ceiling mounted junction box to which the fixture is mounted. A conventional slope adapting mounting arrangement 10 for a ceiling fan, as shown in FIG. 1, includes a hanger bracket 11 for securing to the ceiling mounted junction box 5, and a downrod mounting coupler 15 for securing to the downrod 7 of a ceiling fan 9. The mounting bracket 11 includes a retaining collar 12 with an open side 13 for receiving a necked-down portion 16 of the downrod mounting coupler 15 therethrough. Once received in the mounting bracket 11, a hanger ball portion 17 of the downrod mounting coupler 15 is seated against the retaining collar 12 (by the weight of the attached ceiling fan 9), allowing the downrod mounting coupler 15 (and attached downrod 7 and ceiling fan 9) to swivel or pivot with respect to the mounting bracket 11, positioning the downrod 7 in a substantially vertical orientation. The conventional slope adapting mounting arrangement is typically limited to a maximum pivot range or hanging angle α of approximately 45° with respect to a mount axis Y substantially perpendicular to a mounting plane P defined by the mounting bracket 11. This pivot range may be limited, for example, by the thickness of the necked-down portion 16 and the required seating engagement between the hanger ball portion 17 and the open sided retaining collar 12.

### SUMMARY

The present application is directed to slope adapting mounting arrangements for use with a variety of fixtures, including, for example, ceiling fans. The contemplated slope adapting mounting arrangements may, for example, include features configured to facilitate to orient a fixture at a wider range of slopes or angles with respect to a surface to which the fixture is mounted.

Accordingly, in one embodiment, an exemplary slope adapting mounting arrangement includes a mounting coupler and a mounting bracket. The mounting coupler is configured to attach to a fixture and includes opposed first and second projections. The mounting bracket includes a mounting base defining a mounting plane, and first and second side walls extending from the mounting base and laterally spaced to receive the mounting coupler therebetween. The first and second side walls include first and second recesses for pivotable bearing engagement with the corresponding first and second projections of the mounting coupler. The pivotable bearing engagement between the first and second protrusions and the first and second recesses permits positioning the mounting coupler at any angle within a pivot range of the mounting coupler with respect to a mount axis substantially perpendicular to the mounting plane. The pivotable bearing engagement also prevents the mounting coupler from axially rotating with respect to the mounting bracket.

According to another inventive aspect of the present application, an exemplary method of mounting a ceiling fan to a sloped ceiling is described. In the method, a mounting bracket is affixed to a junction box in the sloped ceiling, with the mounting bracket including first and second laterally spaced side walls. A mounting coupler is affixed with a downrod for a ceiling fan, with the mounting coupler including first and second bearing portions. The first and second bearing portions of the mounting coupler are received in corresponding first and second vertical channels in the first and second side walls. The first and second bearing portions are in pivotable bearing engagement with first and second bearing surfaces in the first and second vertical channels. The mounting coupler is pivoted with respect to the mounting bracket to position the downrod in a vertical orientation. The ceiling fan is then assembled to the downrod.

### BRIEF DESCRIPTION OF THE DRAWINGS

FIG. 1 is a side elevational cross-sectional view of a conventional slope adapting mounting arrangement for a ceiling fan;

FIG. 2A is a front cross-sectional schematic view of an exemplary slope adapting mounting arrangement;

FIG. 2B is a side elevational schematic view of the slope adapting mounting arrangement of FIG. 2A;

FIG. 3 is a partial side elevational view, shown in partial cross-section, of an exemplary slope adapting mounting arrangement;

FIG. 4A is a front perspective view of the mounting coupler of the arrangement of FIG. 3;

FIG. 4B is a right side perspective view of the mounting coupler of the arrangement of FIG. 3;

FIG. 4C is a left side perspective view of the mounting coupler of the arrangement of FIG. 3;

FIG. 4D is a rear cross-sectional view of the mounting coupler of the arrangement of FIG. 3;

FIG. 5A is a front elevational view of the mounting bracket body of the arrangement of FIG. 3;

FIG. 5B is a front cross-sectional view of the mounting bracket body of the arrangement of FIG. 3;

FIG. 5C is a top plan view of the mounting bracket body of the arrangement of FIG. 3;

FIG. 5D is a side cross-sectional view of the mounting bracket body of the arrangement of FIG. 3;

FIGS. 6A and 6B illustrate side elevational and top plan views of the mounting plate of the arrangement of FIG. 3;

FIGS. 7A and 7B illustrate side elevational and top plan views of the canopy of the arrangement of FIG. 3;

FIGS. 8A and 8B illustrate side cross-sectional and bottom plan views of the canopy screw cover of the arrangement of FIG. 3; and

FIG. 9 is a block diagram illustrating an exemplary method for mounting a ceiling fan to a sloped ceiling.

### DESCRIPTION

The present application contemplates arrangements for mounting a fixture (e.g., a ceiling fan or lighting fixture) to ceilings of varying slope (e.g., slopes ranging from 0° to 60° or more from horizontal). While the present application describes exemplary embodiments including slope adapting mounting arrangements for ceiling fans, it is to be understood that many of the inventive features of the present application may be utilized with other types mountable fixtures and devices, including, for example, lighting fixtures and video monitors, and for mounting to other external structures and surfaces, such as, for example, floors, walls, and cabinets.

According to an inventive aspect of the present application, a slope adapting mounting arrangement for a fixture may include a mounting bracket securable to an external structure (e.g., a junction box) and a mounting coupler securable to the fixture. The mounting bracket may be configured to securely retain the mounting coupler in pivoting engagement with the mounting bracket over a desired pivot range.

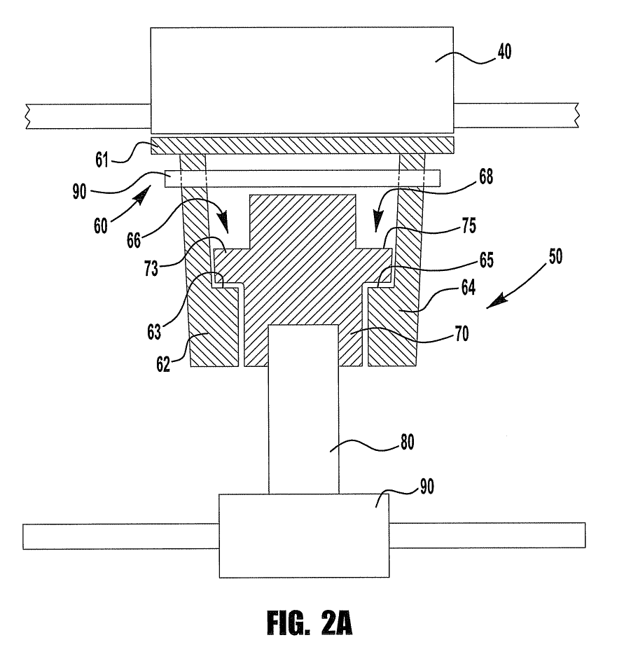

In one embodiment, as shown schematically in FIGS. 2A and 2B, a slope adapting mounting arrangement 50 includes a mounting coupler 70 configured to attach to a fixture (e.g., a downrod 80 and ceiling fan 90), and a mounting bracket 60 having first and second side walls 62, 64 extending from a base portion 61 configured to be attached to an external structure (e.g., an in-ceiling junction box 40). The first and second side walls 62, 64 are laterally spaced to receive the mounting coupler 70 therebetween. In another embodiment (not shown), the mounting coupler may be provided with side walls spaced to receive a portion of the mounting bracket therebetween. The side walls 62, 64 of the illustrated embodiment include first and second bearing surfaces 63, 65 positioned to receive and retain corresponding first and second bearing portions 73, 75 of the mounting coupler 70 to provide for pivotable bearing engagement between the bearing portions 73, 75 and the bearing surfaces 63, 65. While the bearing portions and bearing surfaces may be provided in any suitable arrangement or configuration, in the illustrated embodiment, the bearing portions 73, 75 are provided on laterally extending bosses or protrusions (FIG. 2A), and the bearing surfaces 63, 65 are provided on laterally extending recesses or channels (FIG. 2B) sized to receive the protrusions 73, 75. In one embodiment, the protrusions may be substantially cylindrical to facilitate pivotable movement and to provide uniform pivotable bearing engagement to any angle or position over an entire pivot range of the mounting coupler. In another embodiment, the bearing portions may be provided as recesses on the mounting coupler, with the bearing surfaces of the side walls being disposed on protrusions received in the recesses.

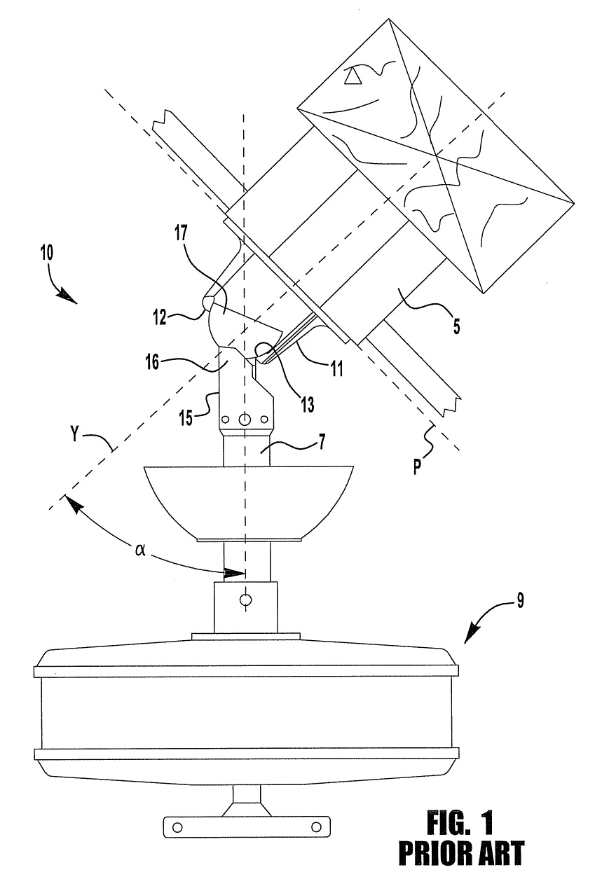

Unlike the conventional slope adapting mounting arrangement 10 of FIG. 1, which utilizes a ring of bearing engagement between the hanger ball portion 17 and the retaining collar 12, the inventive mounting arrangement 50 of FIGS. 2A and 2B provides bearing engagement at discrete side locations between the bearing portions 73, 75 and bearing surfaces 63, 65. The absence of a retaining collar (as provided in the mounting arrangement 10 of FIG. 1) allows for a greater pivot range of the mounting coupler 70 with respect to a mount axis Y substantially perpendicular to a mounting plane P defined by the mounting bracket base portion 61, for mounting to surfaces having greater slopes or in applications requiring a greater angled orientation, for example, than can be provided by the conventional slope adapting mounting arrangement 10 of FIG. 1. In one embodiment, the mounting arrangement 50 is configured to permit a pivot range or hanging angle β of greater than 45°. In other embodiments, the mounting arrangement 50 is configured to permit other pivot ranges or hanging angles β, for example greater than 50° or greater than 55°, or approximately 60°.

The downrod 80 may be maintained in a vertical orientation merely by the weight of the ceiling fan 90 pivoting and holding the mounting coupler 70 in the vertical position. In other embodiments, a fastener or tightening mechanism may be utilized to secure the mounting coupler at a hanging angle that corresponds to the downrod's vertical position. For example, a fastener may be used to clamp the side walls 62, 64 against the mounting coupler 70 at a desired orientation.

To retain the mounting coupler in pivotable bearing engagement with the side walls of the mounting bracket, the bearing surfaces may be provided on channels in the side walls that are shaped to receive the bearing portions horizontally into alignment with the bearing surfaces, and then receive the bearing portions vertically into engagement with the bearing surfaces. As shown in FIG. 2B, the bearing surfaces 63, 65 include, or are provided on, L-shaped channels 66, 68 in the sidewalls 62, 64 that include horizontal channel portions 66a, 68a to permit horizontal insertion of the mounting coupler 70 between the side walls 62, 64, and vertical channel portions 66b, 68b to permit vertical movement of the bearing portions 73, 75 against the bearing surfaces 63, 65 at the ends of the vertical channel portions. Once the protrusions are received in the vertical channel portions, horizontal movement of the mounting coupler 70 with respect to the side walls 62, 64 is prevented, as is axial rotation of the mounting coupler 70 with respect to the mounting bracket 60.

While retention of the mounting coupler 70 in the mounting bracket 60 may be provided entirely by the weight of the mounted fixture 80, 90 on the mounting coupler 70, according to an inventive aspect of the present application, a retaining member 90 may be assembled with the mounting bracket (e.g., with one or both of the side walls 62, 64) to prevent the bearing portions 73, 75 from being lifted out of the vertical channel portions for separation of the mounting coupler 70 from the mounting bracket 60. The retaining member 90 may include any suitable component or components, including for example, fasteners (bolts, pins, etc.) or inserts.

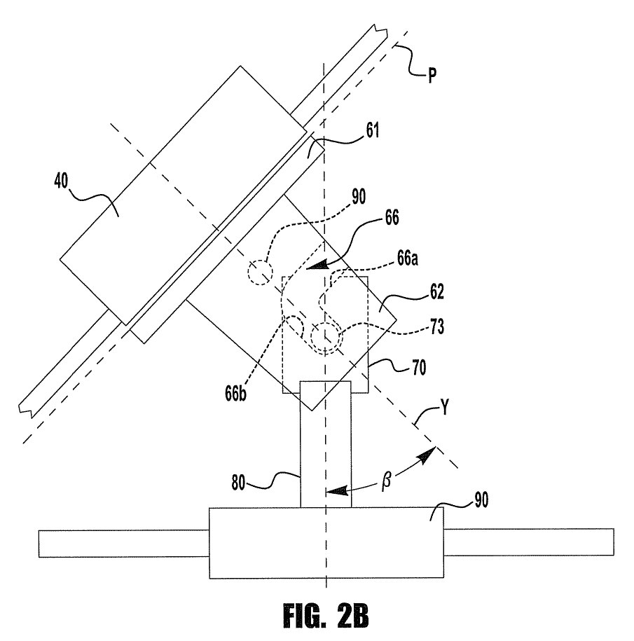

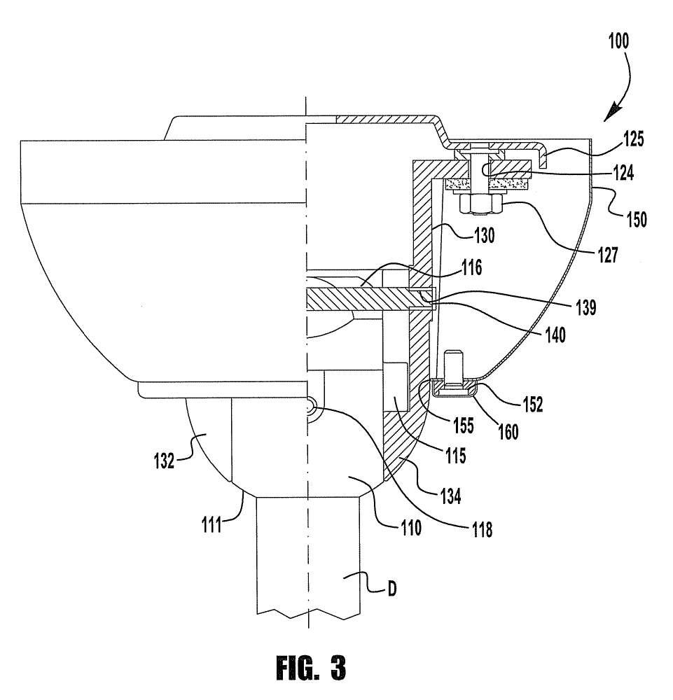

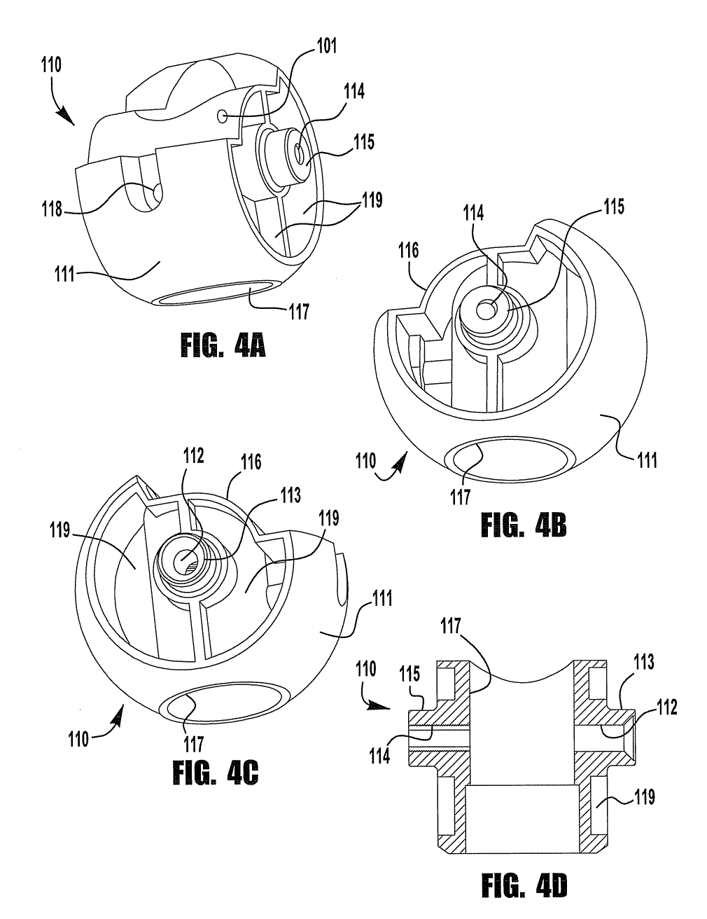

FIGS. 3-8B illustrate an exemplary embodiment of a slope adapting mounting arrangement 100 that may be used, for example, to mount a ceiling fan to a sloped ceiling. The exemplary mounting arrangement 100 includes a mounting coupler 110 (FIGS. 4A-4H), mounting bracket 120, retaining member 140, and canopy 150 (FIGS. 7A and 7B).

The exemplary mounting coupler 110 includes a central bore 117 for receiving a downrod D of a ceiling fan fixture (or to any other suitable fixture or fixture component). The mounting coupler 110, shown more clearly in FIGS. 4A-4D, includes first and second bearing protrusions or bosses 113, 115 extending from the sides of the mounting coupler 110. As shown, the bosses 113, 115 may be provided with mounting holes 112, 114 (one or both of which may be threaded) for receiving a bolt or other fastener to secure the downrod D to the mounting coupler 110 (by insertion through aligned holes in the downrod D, not shown). While the mounting coupler is shown as having a spherical external surface 111, as this surface is not a bearing surface, other shapes and contours may be utilized. Further, as shown, the sides of the mounting coupler 110 may, but need not, be provided with cavities or hollow portions 119, for example, to reduce the weight or amount of material used for the mounting coupler 110.

As shown in FIGS. 3 and 4A, the mounting coupler 110 may be provided with a mounting hole 118 for receiving a fastener (e.g., a set screw, not shown) to further secure the mounting coupler 110 to the downrod D. As shown, the mounting hole 118 may, but need not, be disposed in a recess in the surface of the mounting coupler 110.

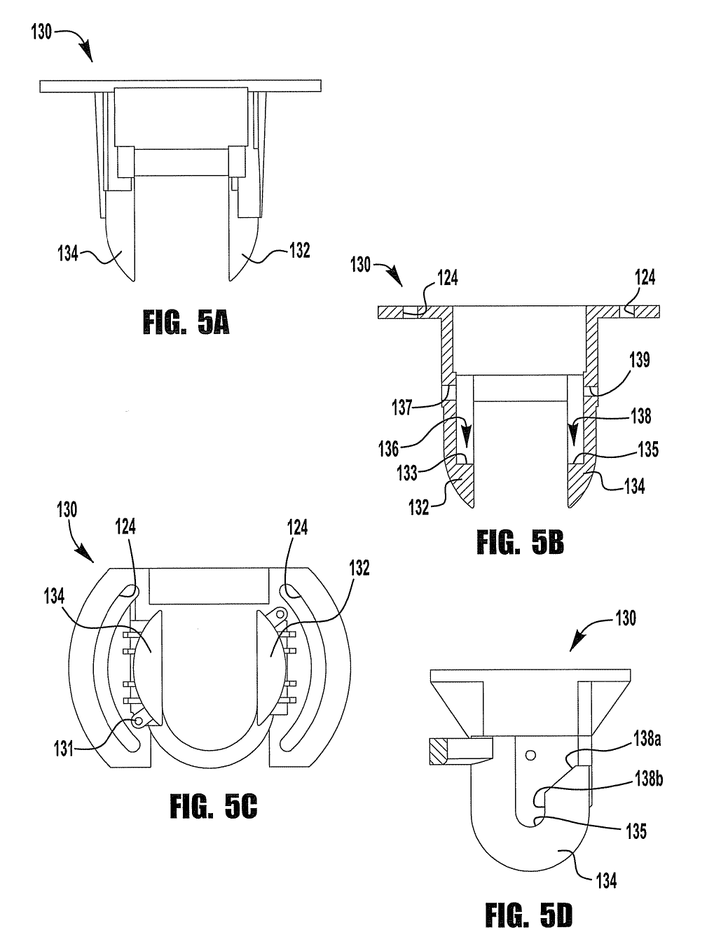

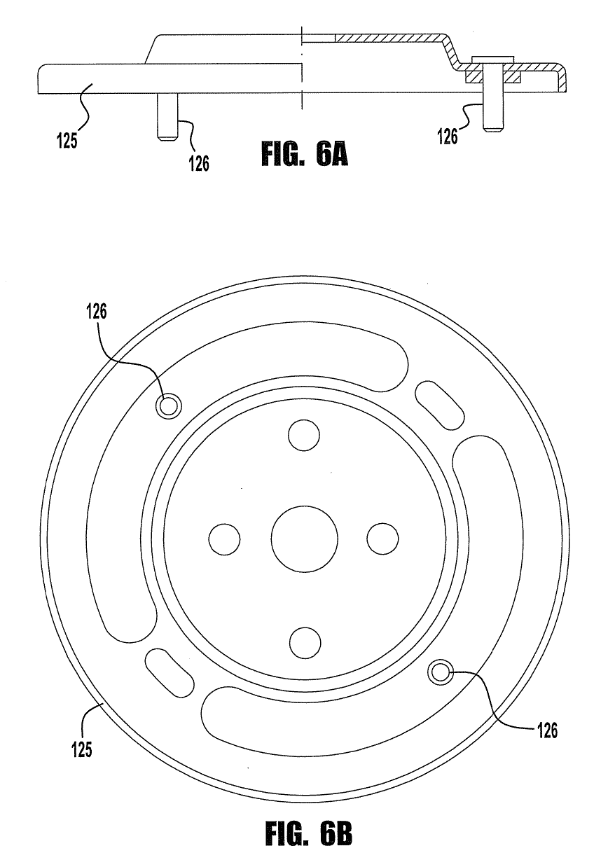

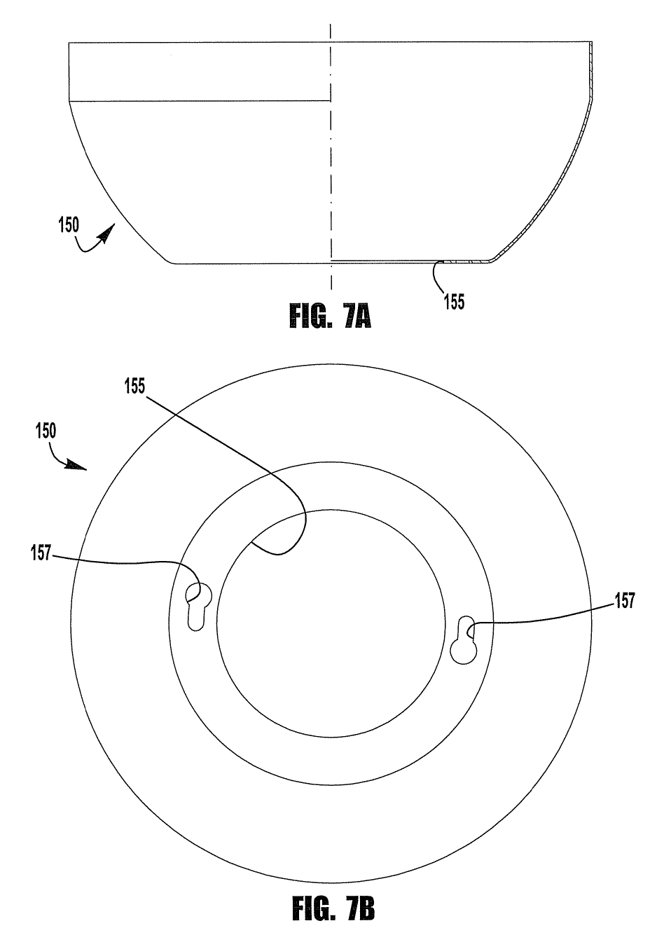

While the mounting bracket may be provided as a single piece component, in the illustrated embodiment, the mounting bracket 120 is formed from a mounting plate 125 (see FIGS. 6A and 6B) that is securable to a junction box (or other external structure) by fasteners 126 and a mounting bracket body 130 (see FIGS. 5A-5D) that is assembled to the mounting plate 125 (e.g., by bolts or other fasteners 127, FIG. 3). The mounting bracket body 130 includes side walls 132, 134 that are laterally spaced to receive the mounting coupler 110 therebetween. In the illustrated embodiment, as shown in FIG. 5C, the bracket body 130 includes elongated, arcuate slots 124 that allow the position of the bracket body 130 to be rotatable with respect to the mounting plate 125, which allows for adjustment of the orientation of the side walls 132, 134 with respect to the junction box. In another embodiment, elongated, arcuate mounting slots may additionally or alternatively be provided on the mounting plate 125 for similar rotational adjustment.

While the side walls 132, 134 may be provided in any suitable shape or size, in the illustrated embodiment, the side walls 132, 134 are provided with an arcuate contoured (e.g., spherical) outer surface, such that the outer surface of the side walls 132, 134 may be substantially flush or continuous with the interposed outer surface 111 of the mounting coupler 110. This provides a uniformity of appearance between the mounting bracket body 130 and mounting coupler 110 that is not present in the conventional mounting arrangement 10 of FIG. 1.

The bracket side walls 132, 134 each include channels 136, 138 oriented to receive the bearing protrusions 113, 115 of the mounting coupler 110 when the mounting coupler 110 is horizontally inserted between the side walls 132, 134. As shown in FIG. 5D, the channels 136, 138 include horizontal portions 138a for horizontally receiving the bearing protrusions 113, 115, and vertical portions 138b for retaining the bearing protrusions against arcuate bearing surfaces 133, 135 in the channels 136, 138. The bearing protrusions 113, 115 are thus retained in pivotable bearing engagement with the bearing surfaces 133, 135.

To prevent the bearing protrusions from being withdrawn from the vertical portions 136b, 138b of the channels 136, 138 (and subsequent separation of the mounting coupler 110 from the mounting bracket body 130), a retaining member 140 may be assembled with the mounting bracket 120 to block vertical movement of the mounting coupler 110. In the illustrated embodiment, a retaining fastener 140 (FIG. 3) is assembled through aligned holes 137, 139 (FIG. 5C) in the side walls 132, 134 (e.g., by threaded engagement with one of the aligned holes 137, 139) to block upward movement of the installed mounting coupler 110. While the retaining fastener 140 may be positioned entirely above the installed mounting coupler 110, in the illustrated embodiment, the retaining fastener 140 is positioned to be disposed in an arcuate cutout 116 (FIGS. 4B and 4C) in the mounting coupler 110, such that the retaining fastener 140 allows for a desired pivot range of the mounting coupler 110.

The canopy 150 of the slope adapting mounting arrangement 100 substantially covers the mounting bracket 120 to provide a finished appearance for the mounted fixture. The canopy includes a central opening 155 through which the side walls 132, 134 and mounting coupler 110 extend. In the illustrated embodiment, the pivot angle is defined by the pivoted positions at which the attached downrod D (or other fixture component) contacts the canopy 150. Alternatively, the arcuate cutout 116 in the mounting coupler 110 may be sized to further limit the pivot angle of the mounting coupler 110.

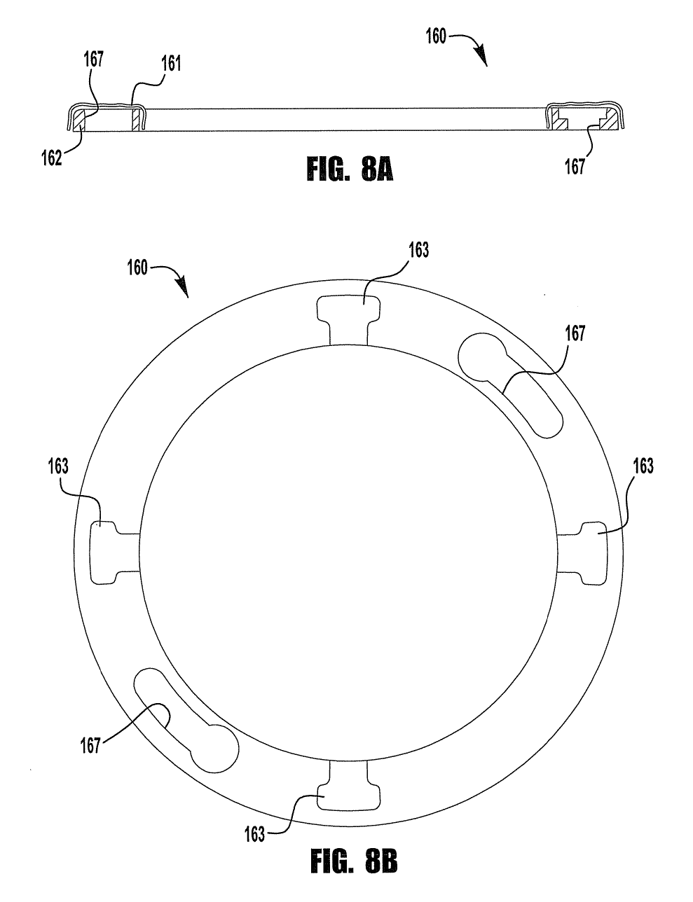

The canopy 150 may be mounted to the mounting bracket body 130, for example, by mounting screws 152. Additionally, a canopy screw cover 160 (see FIGS. 8A and 8B) may be assembled to the canopy 150 to cover the mounting screws 152. The screw cover 160 may include a plastic insert 162 that is secured to a metal shell 161 (e.g., by folded tabs 163 of the shell 161). In the illustrated embodiment, the canopy 150 and canopy screw cover 160 include keyhole shaped mounting holes 157, 167 that interlock with the mounting screws 152 to secure both the canopy 150 and the canopy screw cover 160 to the mounting bracket body 130.

The mounting coupler 110 and mounting bracket body 130 may also be provided with grounding screw holes 101 (FIG. 4A), 131 (FIG. 5D) for securing grounding wires to the mounting coupler 110 and mounting bracket body 130 using grounding screws (not shown). The grounding wires (not shown) may be connected, for example, to the grounding wire of the mounted ceiling fan.

While many different materials may be utilized to construct a slope adapting mounting arrangement having one or more of the inventive features described herein, in one embodiment, the mounting bracket body and mounting coupler are provided in zinc, the mounting plate, fasteners, and canopy are provided in steel, and the canopy screw cover is provided in steel with a plastic insert.

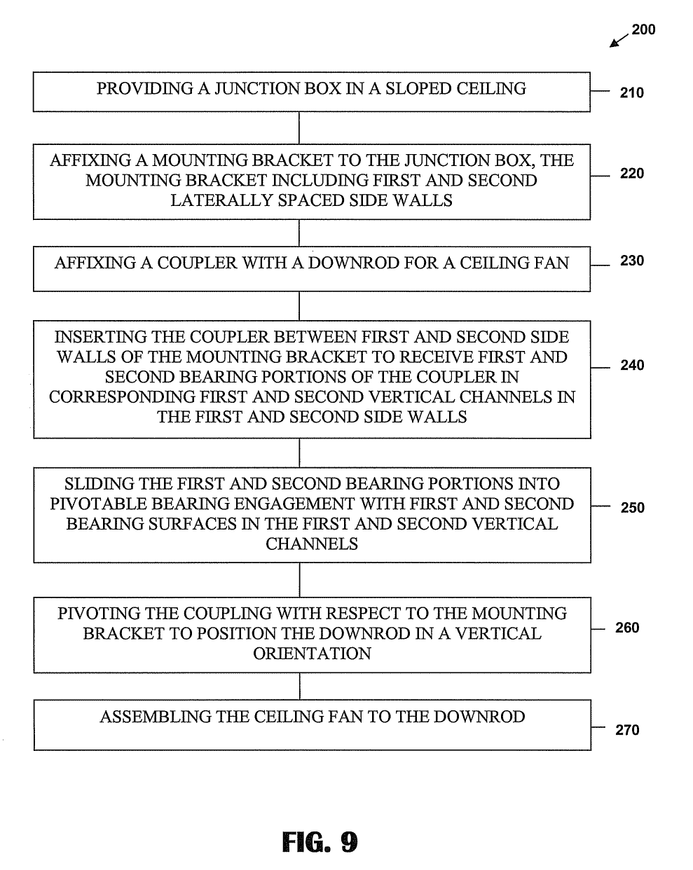

FIG. 9 is a block diagram illustrating an exemplary method 200 for mounting a ceiling fan to a sloped ceiling. In the exemplary method 200, a mounting bracket is affixed to a junction box in a sloped ceiling (block 210), for example, by securing a mounting plate to the junction box and fastening a mounting bracket body to the mounting plate in a desired rotational orientation. A mounting coupler is affixed with a downrod for a ceiling fan (block 220). The mounting coupler is inserted between first and second side walls of the mounting bracket to receive first and second bearing portions of the mounting coupler in corresponding first and second vertical channels in the first and second side walls (block 230). The first and second bearing portions are slid into pivotable bearing engagement with first and second bearing surfaces in the first and second vertical channels (block 240). The mounting coupler is pivoted with respect to the mounting bracket to position the downrod in a vertical orientation (block 250). The ceiling fan is then assembled to the downrod (block 260).

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated. Also, the various features of the mounting arrangements discussed above and claimed below may be considered to be separate building blocks which may provide utility in and of themselves. Thus, it is contemplated that inventive devices and arrangements may be designed based on the teachings herein using virtually any combination or permutation of any one or more of these separate features without necessarily some or all of the other features. Accordingly, it is contemplated that arrangements, devices, and combinations of devices may be claimed using virtually any combination or permutation of any one or more of these features.

1. A slope adapting mounting arrangement for a fixture, the arrangement comprising:
a mounting coupler configured to attach to the fixture, the mounting coupler including opposed first and second projections; and
a mounting bracket having a mounting base defining a mounting plane, and first and second side walls extending from the mounting base and laterally spaced to receive the mounting coupler therebetween, the first and second side walls including first and second recesses for pivotable bearing engagement with the corresponding first and second projections of the mounting coupler;
wherein the pivotable bearing engagement between the first and second protrusions and the first and second recesses permits positioning the mounting coupler at any angle within a pivot range of the mounting coupler with respect to a mount axis substantially perpendicular to the mounting plane; and
further wherein the pivotable bearing engagement prevents the mounting coupler from axially rotating with respect to the mounting bracket.

2. The arrangement of claim 1, wherein the first and second recesses each include a vertically extending channel sized to prevent horizontal movement of the mounting coupler.

3. The arrangement of claim 1, further comprising a retaining member assembled with the mounting bracket to prevent vertical disengagement of the first and second protrusions from the first and second recesses.

4. The arrangement of claim 3, wherein the retaining member comprises a fastener assembled with at least one of the first and second side walls.

5. The arrangement of claim 3, wherein the retaining member comprises a fastener assembled with both of the first and second side walls.

6. The arrangement of claim 3, wherein the mounting coupler comprises a cutout sized to provide clearance for the retaining member over the pivot range of the mounting coupler with respect to the mounting bracket.

7. The arrangement of claim 1, wherein the pivot range is greater than 45°.

8. The arrangement of claim 1, wherein the pivot range is at least approximately 60°.

9. The arrangement of claim 1, further comprising a fastener assembled with both of the first and second side walls to tighten the first and second side walls against the mounting coupler.

10. The arrangement of claim 1, wherein the mounting base of the mounting bracket comprises a mounting plate removably assembled with the first and second side walls.

11. The arrangement of claim 1, wherein the mounting base is rotatably positionable with respect to the first and second side walls.

12. The arrangement of claim 1, further comprising a canopy assembled with the mounting bracket, the canopy including an opening through which the side walls and mounting coupler extend, the opening defining the pivot range of the mounting coupler.

13. The arrangement of claim 1, wherein outer surfaces of the first and second side walls are contoured to be substantially flush with a contoured outer surface of the mounting coupler.

14. The arrangement of claim 1, wherein the first and second protrusions remain in uniform pivotable bearing engagement with the corresponding first and second recesses over the entire pivot range of the mounting coupler.

15. The arrangement of claim 1, further comprising:
a retaining member assembled with the first and second side walls of the mounting bracket to prevent vertical disengagement of the first and second protrusions from the first and second recesses,
wherein the mounting coupler comprises a cutout providing clearance for the retaining member over the pivot range of the mounting coupler with respect to the mounting bracket, the cutout being sized such that the pivot range is greater than 45°; and
further wherein the mounting base of the mounting bracket comprises a mounting plate rotatably positionable with respect to the first and second side walls.

16. A method of mounting a ceiling fan to a sloped ceiling, the method comprising:
providing a mounting bracket affixed to a junction box in the sloped ceiling, the mounting bracket including first and second laterally spaced side walls;
providing a mounting coupler affixed to a downrod for a ceiling fan, the mounting coupler including first and second bearing portions received in corresponding first and second vertical channels in the first and second side walls of the mounting bracket, with the first and second bearing portions being in pivotable bearing engagement with first and second bearing surfaces in the first and second vertical channels;
pivoting the mounting coupler with respect to the mounting bracket to position the downrod in a vertical orientation; and
assembling the ceiling fan to the downrod.

17. The method of claim 16, further comprising assembling a retaining member with at least one of the first and second side walls to prevent withdrawal of the first and second bearing portions from the corresponding first and second vertical channels.

18. The method of claim 16, further comprising assembling a canopy over the mounting bracket, the canopy defining a pivot range of the downrod.

19. The method of claim 16, further comprising rotatably positioning the first and second side walls with respect to the mounting base.

20. A ceiling fan assembly comprising:
a ceiling fan fixture;
a downrod configured to be assembled to the ceiling fan fixture;
a mounting coupler configured to attach to the downrod, the mounting coupler including opposed first and second protrusions;
a mounting bracket having a mounting base for assembly with a junction box, and first and second side walls extending from the mounting base and rotatably positionable with respect to the mounting base, the first and second side walls being laterally spaced to receive the mounting coupler therebetween, the first and second side walls including first and second channels configured to receive the first and second protrusions for pivotable bearing engagement with the first and second protrusions;
a retaining fastener assembled with the first and second side walls to prevent vertical disengagement of the protrusions from the first and second channels; and
a canopy assembled with the mounting bracket, the canopy including an opening through which the side walls and mounting coupler extend, the opening defining a pivot range of the mounting coupler when a fixture is attached to the mounting coupler, wherein the pivot range is greater than 45°.
